(19) United States
(12) Patent Application Publication
(10) Pub. No.: US 2018/0302636 A1
(43) Pub. Date: Oct. 18, 2018

(54) METHOD OF MIXING VIDEO BITSTREAMS AND APPARATUS PERFORMING THE METHOD

(71) Applicant: ELECTRONICS AND TELECOMMUNICATIONS RESEARCH INSTITUTE, Daejeon (KR)

(72) Inventors: Hong Yeon YU, Gwangju (KR); Dae Seon KIM, Gwangju (KR); Kwon-Seob LIM, Gwangju (KR); Eun Kyoung JEON, Gwangju (KR); Jong Jin LEE, Gwangju (KR)

(73) Assignee: ELECTRONICS AND TELECOMMUNICATIONS RESEARCH INSTITUTE, Daejeon (KR)

(21) Appl. No.: 15/882,352

(22) Filed: Jan. 29, 2018

(30) Foreign Application Priority Data
Apr. 18, 2017 (KR) 10-2017-0049606

(51) Int. Cl. H04N 19/31; H04N 19/80; H04N 19/33; H04N 19/70

(52) U.S. Cl. CPC H04N 19/31; H04N 19/70; H04N 19/33; H04N 19/80

(57) ABSTRACT

A method of mixing video bitstreams and an apparatus performing the method are disclosed. The method includes generating a mixed scalable video coding (SVC) bitstream by mixing a plurality of SVC bitstreams for each layer based on a screen configuration of a user device, extracting a single SVC bitstream corresponding to a single layer from the mixed SVC bitstream based on a reception environment of the user device, and transmitting the single SVC bitstream to the user device.

### CROSS-REFERENCE TO RELATED APPLICATION

This application claims the priority benefit of Korean Patent Application No. 10-2017-0049606 filed on Apr. 18, 2017, in the Korean Intellectual Property Office, the disclosure of which is incorporated herein by reference.

### BACKGROUND

### 1. Field

Example embodiments of the following description relate to a method of mixing video bitstreams and an apparatus performing the method.

### 2. Description of Related Art

A scalable video coding (SVC) technology is a coding technology for forming layers to allow a single set of video data to have various spatial resolutions, qualities, and frame rates, and providing the layers as a single encoded bitstream to a receiving terminal. For example, H.264/SVC, which is an extended coding method of H.264/advanced video coding (AVC), is an internationally standardized video coding method to effectively transmit a video to various network environments and receiving terminal environments.

The SVC technology may generate an encoded bitstream including a base layer and at least one enhancement layer in a sequential order, using a single set of video data, and transmit the generated encoded bitstream to a receiving terminal. The encoded bitstream may be used for a decoder to restore the enhancement layer based on lower layer information to be suitable for various reception environments including, for example, network environments and resolutions of receiving terminals, and to display an image.

However, in a case in which users simultaneously transmit generated SVC bitstreams at various locations, for example, remote locations, as in multiparty video conferences, large-scale video control services, and multichannel broadcast services, a receiving terminal may need to have a plurality of decoders to extract, restore, and reproduce such multiple SVC bitstreams, simultaneously.

### SUMMARY

According to example embodiments, there is provided a technology for generating a mixed scalable video coding (SVC) bitstream by mixing a plurality of SVC bitstreams for each layer based on a screen configuration of a user device.

According to example embodiments, there is provided a technology for extracting a single SVC bitstream corresponding to a single layer from a mixed SVC bitstream based on a reception environment of a user device.

According to example embodiments, there is provided a technology for decoding a single SVC bitstream and transmitting the decoded SVC bitstream to a user device, thereby reproducing a video encoded by a plurality of SVC bitstreams simultaneously.

The foregoing and/or other aspects are achieved by providing a method of mixing video bitstreams, hereinafter simply referred to as a video bitstream mixing method, including generating a mixed SVC bitstream by mixing a plurality of SVC bitstreams for each layer based on a screen configuration of a user device, extracting a single SVC bitstream corresponding to a single layer from the mixed SVC bitstream based on a reception environment of the user device, and decoding the single SVC bitstream and transmitting the decoded single SVC bitstream to the user device.

The SVC bitstreams each including a single base layer and a plurality of enhancement layers may be transmitted from a plurality of remote locations.

The generating of the mixed SVC bitstream may include analyzing the SVC bitstreams by each network abstraction layer (NAL) unit, and mixing the analyzed SVC bitstreams based on a screen arrangement configuration parameter of the user device in response to a result of the analyzing.

The analyzing of the SVC bitstreams may include identifying a NAL unit by analyzing information of a header of a NAL unit of each of the SVC bitstreams, and selecting a NAL unit of the SVC bitstreams based on the screen arrangement configuration parameter of the user device in response to a result of the identifying.

The mixing of the SVC bitstreams may include changing a sequence parameter set (SPS) of a reference bitstream among the analyzed SVC bitstreams, changing a slice header of each of the analyzed SVC bitstreams based on the screen arrangement configuration parameter of the user device, and generating the mixed SVC bitstream by re-arranging changed SVC bitstreams based on an order of a plurality of layers included in each of the changed SVC bitstreams.

The changing of the SPS may include changing a field value of a horizontal size and a field value of a vertical size of a final screen to be mixed based on a resolution of a finally mixed screen.

The changing of the slice header may include changing a macro-block start address field value of a slice header associated with slice data of a base layer and an enhancement layer included in each of the analyzed SVC bitstreams.

The generating of the mixed SVC bitstream may include calculating a bit number of a NAL unit including slice data of each of the changed SVC bitstreams based on macro-block address information of a slice header associated with slice data of each of a base layer and an enhancement layer included in each of the changed SVC bitstreams.

The calculating of the bit number may include arranging bytes of a slice NAL unit by inserting a raw byte sequence payload (RBSP) trailing bit into calculated slice data.

The foregoing and/or other aspects are achieved by providing an apparatus for mixing video bitstreams, hereinafter simply referred to as a video bitstream mixing apparatus, including a mixer configured to generate a mixed SVC bitstream by mixing a plurality of SVC bitstreams for each layer based on a screen configuration of a user device, an extractor configured to extract a single SVC bitstream corresponding to a single layer from the mixed SVC bitstream based on a reception environment of the user device, and a decoder configured to decode the single SVC bitstream and transmit the decoded single SVC bitstream to the user device.

The SVC bitstreams each including a base layer and a plurality of enhancement layers may be transmitted from a plurality of remote locations.

The mixer may include a buffer configured to provide the SVC bitstreams by each NAL unit based on a buffer fullness, an analyzer configured to analyze the SVC bitstreams by each NAL unit, and a processor configured to mix the analyzed SVC bitstreams based on a screen arrangement configuration parameter of the user device in response to a result of the analyzing.

The analyzer may identify a NAL unit by analyzing information of a header of a NAL unit of each of the SVC bitstreams, and select a NAL unit of the SVC bitstreams based on the screen arrangement configuration parameter of the user device in response to a result of the identifying.

The processor may include a first converter configured to change an SPS of a reference bitstream among the analyzed SVC bitstreams, a second converter configured to change a slice header of each of the analyzed SVC bitstreams based on the screen arrangement configuration parameter of the user device, and a generator configured to generate the mixed SVC bitstream by re-arranging changed SVC bitstreams based on an order of a plurality of layers included in each of the changed SVC bitstreams.

The first converter may change a field value of a horizontal size and a field value of a vertical size of a final screen to be mixed based on a resolution of a finally mixed screen.

The second converter may change a macro-block start address field value of a slice header associated with slice data of a base layer and an enhancement layer included in each of the analyzed SVC bitstreams.

The generator may calculate a bit number of a NAL unit including slice data of each of the changed SVC bitstreams based on macro-block address information of a slice header associated with slice data of each of a base layer and an enhancement layer included in each of the changed SVC bitstreams.

The generator may arrange bytes of a slice NAL unit by inserting an RBSP trailing bit into calculated slice data.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating a system for mixing video bitstreams, hereinafter simply referred to as a video bitstream mixing system, according to an example embodiment;

FIG. 2 is a diagram illustrating an apparatus for mixing video bitstreams, hereinafter simply referred to as a video bitstream mixing apparatus, of the video bitstream mixing system illustrated in FIG. 1;

FIG. 3 is a diagram illustrating a controller of the video bitstream mixing apparatus illustrated in FIG. 2;

FIG. 4 is a diagram illustrating a mixer of the controller illustrated in FIG. 3;

FIG. 5 is a diagram illustrating a processor of the mixer illustrated in FIG. 4;

FIG. 6 is a diagram illustrating an example of a configuration of a scalable video coding (SVC) bitstream according to an example embodiment;

FIG. 7 is a diagram illustrating an example of a configuration of a network abstraction layer (NAL) unit of an SVC bitstream according to an example embodiment;

FIG. 8 is a diagram illustrating examples of a single SVC bitstream according to an example embodiment;

FIG. 9 is a diagram illustrating examples of a screen configuration of a user device according to an example embodiment;

FIG. 10 is a diagram illustrating an example of an operation of a mixer according to an example embodiment; and

FIG. 11 is a flowchart illustrating an example of a method to be performed by the video bitstream mixing apparatus illustrated in FIG. 1.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described herein that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, example embodiments are described in detail with reference to the accompanying drawings. Like reference numerals in the drawings denote like elements, and a known function or configuration will be omitted herein.

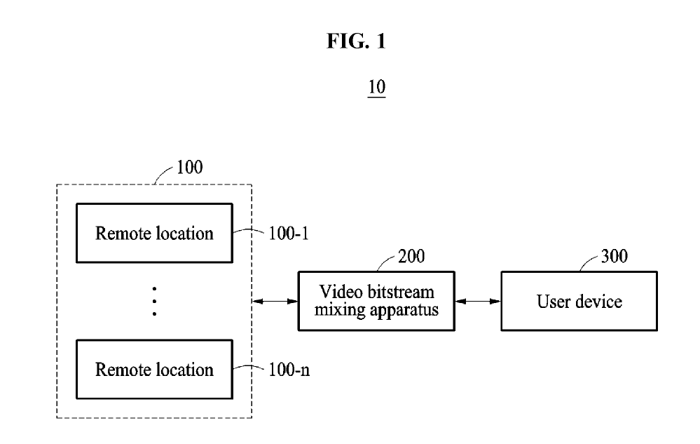

FIG. 1 is a diagram illustrating a system for mixing video bitstreams according to an example embodiment. The system for mixing video bitstreams will be simply referred to as a video bitstream mixing system hereinafter.

Referring to FIG. 1, a video bitstream mixing system 10 includes a plurality of remote locations 100, an apparatus for mixing video bitstreams, which will be simply referred to as a video bitstream mixing apparatus 200 hereinafter, and a user device 300.

Each of the remote locations 100 may communicate with the video bitstream mixing apparatus 200. For example, the remote locations 100 may simultaneously transmit respective scalable video coding (SVC) bitstream to the video bitstream mixing apparatus 200. Here, an SVC bitstream may be an encoded SVC bitstream that is classified into a base layer and a plurality of enhancement layers based on a spatial and temporal element, and an image quality element.

The remote locations 100 include a first remote location 100-1 through an n-th remote location 100-n, where n denotes a natural number greater than or equal to 1.

Each of the remote locations 100 may be embodied in an electronic device. The electronic device may include, for example, a personal computer (PC), a data server, and a portable device.

The portable device may include, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, and a smart device. The smart device may include, for example, a smart watch and a smart band.

The video bitstream mixing apparatus 200 may communicate with the user device 300. The video bitstream mixing apparatus 200 may provide the user device 300 with a multilateral video conference service, a large-scale video monitoring service, and a multichannel broadcasting service.

For example, the video bitstream mixing apparatus 200 may mix a plurality of SVC bitstreams transmitted simultaneously from the remote locations 100, and transmit the mixed SVC bitstream to the user device 300.

The video bitstream mixing apparatus 200 may reconstruct a single SVC bitstream including a plurality of layers by changing and adding a portion of coding parameters of a bit string included in a bitstream, instead of decoding a plurality of SVC bitstreams including a plurality of layers into pixel units. Subsequently, the video bitstream mixing apparatus 200 may extract an SVC bitstream corresponding to a single layer among the plurality of layers included in the single SVC bitstream based on a reception environment of the user device 300, and transmit the extracted SVC bitstream to the user device 300.

The video bitstream mixing apparatus 200 may provide the user device 300 with the single SVC bitstream that is used to simultaneously restore and reproduce, in real time, the plurality of SVC bitstreams simultaneously transmitted from the remote locations 100. In addition, the video bitstream mixing apparatus 200 may perform the mixing unrestrictedly, from a low-resolution video to a high-resolution video, based on a reference image in a bit string mixing process.

The video bitstream mixing apparatus 200 may be provided along with the user device 300. In addition, the video bitstream mixing apparatus 200 may be provided, in advance, in a multipoint control unit (MCU) or an SVC control server based on an environment of the user device 300.

The user device 300 may display a video bitstream. For example, the user device 300 may display an SVC bitstream transmitted from the video bitstream mixing apparatus 200. Here, the SVC bitstream may be a decoded SVC bitstream.

The user device 300 may not experience an image quality deterioration that may be caused by mixing or re-coding a plurality of SVC bitstreams into pixel units.

The user device 300 may be embodied in an electronic device including an SVC bitstream decoder. The electronic device may include, for example, a PC, a data server, and a portable device.

The portable device may include, for example, a desktop computer, a laptop computer, a mobile phone, a smartphone, a tablet PC, an MID, a PDA, an EDA, a digital still camera, a digital video camera, a PMP, a PND, a handheld game console, an e-book, and a smart device. The smart device may include, for example, a smart watch and a smart band.

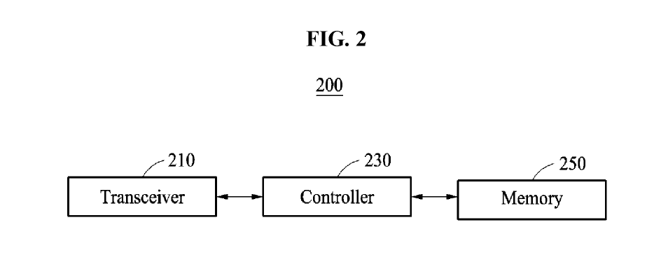

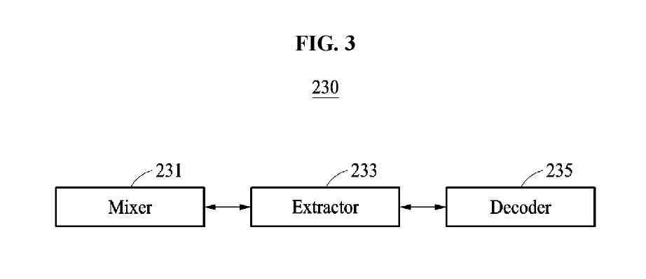

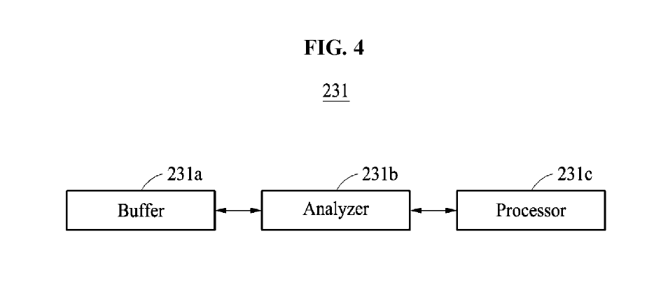

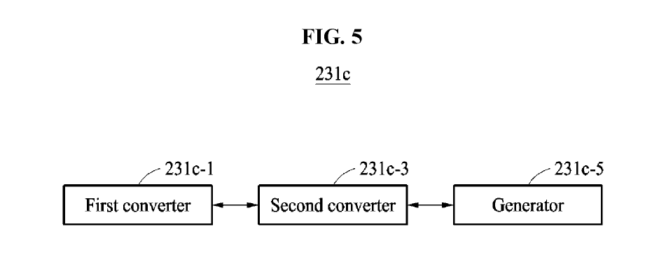

FIG. 2 is a diagram illustrating the video bitstream mixing apparatus 200 of the video bitstream mixing system 10 illustrated in FIG. 1. FIG. 3 is a diagram illustrating a controller of the video bitstream mixing apparatus 200 illustrated in FIG. 2. FIG. 4 is a diagram illustrating a mixer of the controller illustrated in FIG. 3. FIG. 5 is a diagram illustrating a processor of the mixer illustrated in FIG. 4.

Referring to FIG. 2, the video bitstream mixing apparatus 200 includes a transceiver 210, a controller 230, and a memory 250.

The transceiver 210 may communicate with the remote locations 100 and the user device 300. The transceiver 210 may communicate with the remote locations 100 and the user device 300 based on various communication protocols including, for example, orthogonal frequency-division multiple access (OFDMA), single-carrier frequency-division multiple access (SC-FDMA), generalized frequency-division multiplexing (GFDM), universal-filtered multi-carrier (UFMC), filter bank multi-carrier (FBMC), biorthogonal frequency-division multiplexing (BFDM), non-orthogonal multiple access (NOMA), code-division multiple access (CDMA), and Internet of things (IOT).

The transceiver 210 may receive a plurality of SVC bitstreams from the remote locations 100. Each of the SVC bitstreams transmitted from the remote locations 100 may include a plurality of layers including, for example, a single base layer and a plurality of enhancement layers.

The transceiver 210 may transmit a video bitstream to the user device 300. The video bitstream may be a single SVC bitstream including a single layer, which is generated by the video bitstream mixing apparatus 200 and is to be displayed on the user device 300.

The controller 230 may control an overall operation of the video bitstream mixing apparatus 200. For example, the controller 230 may control an operation of each of the components described herein, for example, the transceiver 210 and the memory 250.

The controller 230 may obtain video bitstreams received through the transceiver 210. For example, the controller 230 may obtain the SVC bitstreams received through the transceiver 210. The controller 230 may store the SVC bitstreams in the memory 250.

The controller 230 may generate a single video bitstream by mixing the SVC bitstreams. For example, the controller 230 may generate a single mixed SVC bitstream by mixing the SVC bitstreams for each layer based on a screen configuration of the user device 300. The controller 230 may store the single mixed SVC bitstream in the memory 250.

The controller 230 may extract and decode a video bitstream. For example, the controller 230 may extract and decode a single SVC bitstream corresponding to a single layer from the mixed SVC bitstream based on a reception environment of the user device 300. The controller 230 may store the extracted and decoded single SVC bitstream in the memory 250.

Referring to FIG. 3, the controller 230 includes a mixer 231, an extractor 233, and a decoder 235.

The mixer 231 may generate a single video bitstream by mixing a plurality of video bitstreams. For example, the mixer 231 may generate a mixed SVC bitstream including a plurality of layers by mixing, for each layer, a plurality of SVC bitstreams each including a plurality of layers based on a screen configuration of the user device 300.

The mixer 231 may generate the mixed SVC bitstream including the layers by mixing the SVC bitstreams including the layers for each layer based on the screen configuration of the user device 300 to configure the SVC bitstreams including the layer to be a video including the layers of a same resolution or to be a single high-resolution video and a plurality of low-resolution videos. Here, the mixed SVC bitstream may be a single SVC bitstream including a single base layer and at least one enhancement layer.

The extractor 233 may extract a video bitstream including a single layer from a video bitstream including a plurality of layers. For example, the extractor 233 may extract a single SVC bitstream corresponding to a single layer from the mixed SVC bitstream including the layers based on a reception environment of the user device 300. Here, the single SVC bitstream may be a mixed video bitstream including a single layer.

The decoder 235 may decode a video bitstream. For example, the decoder 235 may decode the extracted single SVC bitstream to be displayed on the user device 300.

Referring to FIG. 4, the mixer 231 includes a buffer 231a, an analyzer 231b, and a processor 231c.

The buffer 231a may provide the analyzer 231b with a plurality of video bitstreams by a network abstraction layer (NAL) unit. For example, the buffer 231a may provide, by the NAL unit, the analyzer 231b with a plurality of SVC bitstreams including a plurality of layers that is received by a group of pictures (GOP) unit based on buffer fullness.

The analyzer 231b may analyze the video bitstreams by each NAL unit. Here, the NAL unit may include a non-video coding layer (VCL) NAL unit and a VCL NAL unit, along with a NAL unit header that may classify NAL unit types and layers of an SVC bitstream, and may include a single base layer and at least one enhancement layer based on spatial, temporal, and image quality elements of an SVC bitstream for each frame unit.

The non-VCL NAL unit may include sequence parameter set (SPS) data, picture parameter set (PPS) data, and supplemental enhancement information (SEI) data. The SPS data may define a parameter associated with entire encoding including, for example, a video profile, a label, and a resolution of an SVC bitstream. The PPS data may define a parameter associated with an encoding frame unit including, for example, an entropy coding mode, a slice group type, and a quantization property. The SEI data may define layer information.

The VCL NAL unit may include slice data along with a slice header, for example, a slice header in scalable extension, based on a base layer and an enhancement layer. The slice data may be encoded by a macro-block unit included in a single frame. The single frame included in the slice data may include a single slice, or a plurality of slices.

Thus, the analyzer 231b may identify various types of NAL units of video bitstreams, and select NAL units to be used by the processor 231c to perform the mixing based on each layer. For example, the analyzer 231b may identify a NAL unit based on information of a header of the NAL unit of each SVC bitstream, and select a plurality of SVC bitstreams based on a screen arrangement configuration parameter of the user device 300 in response to a result of the identifying.

For example, the analyzer 231b may set a reference bitstream among a plurality of SVC bitstreams based on the screen arrangement configuration parameter of the user device 300. The reference bitstream may be an SVC bitstream, which is a reference for the mixing.

Subsequently, the analyzer 231b may provide the processor 231c with a non-VCL NAL unit of the reference bitstream, and may not provide the processor 231c with a non-VCL NAL unit of bitstreams that are not the reference bitstream. The analyzer 231b may also provide the processor 231c, for each NAL unit, with encoded slice data of a VCL NAL unit of each of a base layer and an enhancement layer included in each of the SVC bitstreams, along with slice header and slice header in scalable extension information. In addition, the analyzer 231b may determine layer information of the SVC bitstreams using information of a NAL unit of the SEI data, identify a NAL unit included in each of a plurality of layers based on a dependency identification (ID) field value, a quality ID field value, and a temporal ID field value of a NAL unit header SVC extension. The analyzer 231b may then sequentially provide NAL units to the processor 231c based on a mixing order.

The processor 231c may generate a single video bitstream by mixing a plurality of analyzed video bitstreams. For example, in response to a result of the analyzing, the processor 231c may mix a plurality of SVC bitstreams including a plurality of layers based on the screen arrangement configuration parameter of the user device 300, and generate the mixed SVC bitstream including a plurality of layers. In detail, in response to the result of the analyzing, the processor 231c may reconstruct a complex SVC bitstream from the SVC bitstreams by selectively changing a non-VCL NAL unit and a VCL NAL unit included in each of the layers based on the screen arrangement configuration parameter of the user device 300.

Referring to FIG. 5, the processor 231c includes a first converter 231c-1, a second converter 231c-3, and a generator 231c-5.

The first converter 231c-1 may change SPS information of a reference SVC bitstream. For example, the first converter 231c-1 may change the SPS information of the reference SVC bitstream based on a screen arrangement configuration parameter of the user device 300.

In detail, the first converter 231c-1 may change a parameter, or a field value, for configuring a screen arrangement of the user device 300, which is included in the SPS information of the reference SVC bitstream. For example, the first converter 231c-1 may change resolution information associated with a resolution of a screen to be mixed with respect to the SPS information of the reference SVC bitstream based on a resolution of a finally mixed screen to be displayed on the user device 300. Here, the resolution information may be a ‘pic_width_in_mbs_minus1’ field value indicating a size of a width of a final screen to be mixed, and a ‘pic_height_in_mbs_minus1’ field value indicating a size of a height of the final screen.

The second converter 231c-3 may change a slice header of slice data of each of analyzed SVC bitstreams based on a base layer and an enhancement layer. For example, the second converter 231c-3 may change the slice header of the slice data of each of the analyzed SVC bitstreams based on a screen arrangement configuration parameter of the user device 300.

In detail, the second converter 231c-3 may change a macro-block address field value of a slice header of slice data included in a base layer and an enhancement layer of each of the analyzed SVC bitstreams. The second converter 231c-3 may change a ‘first_mb_in_slice’ field value indicating a start macro-block address of a slice header included in a single screen based on the screen arrangement configuration parameter of the user device 300.

That is, the second converter 231c-3 may set the start macro-block address of the slice header included in the single screen to be the reference SVC bitstream, and change the ‘first_mb_in_slice’ field value of the slide header to a new macro-block address based on the screen arrangement configuration.

A field value of a slice header may be a slice header and slice header in scalable extension field value of slice data of each of a base layer and an enhancement layer of a plurality of SVC bitstreams to be included in a screen to be mixed.

The generator 231c-5 may generate a single video bitstream by re-arranging a plurality of video bitstreams. For example, the generator 231c-5 may generate a mixed SVC bitstream by re-arranging a plurality of changed SVC bitstreams based on an order of each of a plurality of layers. Here, the re-arranging of the changed SVC bitstreams may indicate re-arranging NAL units of the changed SVC bitstreams. In detail, the generator 231c-5 may calculate a bit number of a NAL unit including slice data of each of the changed SVC bitstreams based on macro-block address information of a slice header associated with the slice data of each of the changed SVC bitstreams, insert a raw byte sequence payload (RBSP) trailing bit to the calculated slice data, and perform byte ordering on final bits, to generate the mixed SVC bitstream in which bytes of NAL units are arranged. Here, a bit number of the calculated slice data may be a final byte of increased or decreased slice data. In addition, the RBSP trailing bit may be 0.

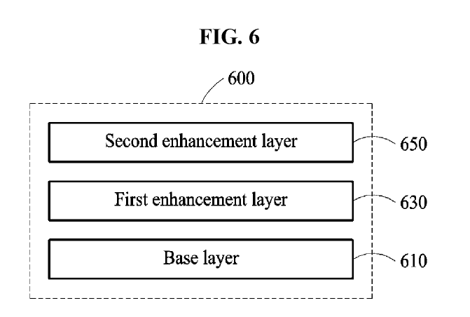

FIG. 6 is a diagram illustrating a structure of an SVC bitstream according to an example embodiment.

Referring to FIG. 6, an SVC bitstream 600 includes a plurality of layers. In detail, the SVC bitstream 600 includes a single base layer 610, and a plurality of enhancement layers. The enhancement layers of the SVC bitstream 600 include a first enhancement layer 630 and a second enhancement layer 650.

The SVC bitstream 600 may be a compressed bitstream encoded using an SVC method of an H. 264/advanced video coding (AVC) by a joint video team (JVT) of the SVC international organization for standardization (ISO)/international electrotechnical commission (IEC) moving picture experts group (MPEG) and the international telecommunication union-telecommunication standardization sector (ITU-T) video coding experts group (VCEG). The SVC method may be an international standardized video coding method to effectively transmit a video in various network environments and various receiving terminal environments.

In addition, the SVC bitstream 600 may be received and restored through a selective adjustment of a video resolution, a frame rate, a signal-to-noise ratio (SNR), and the like based on a reception environment of the user device 300.

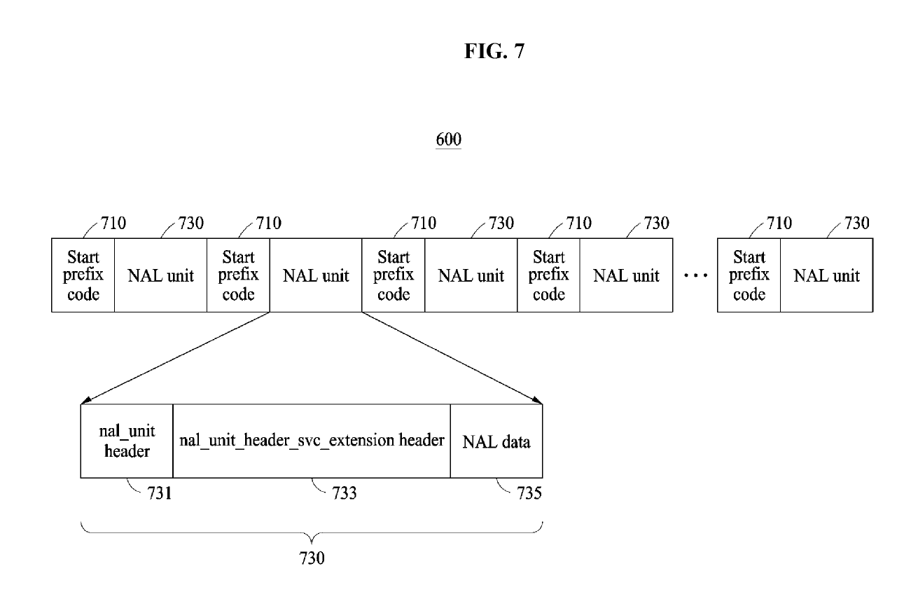

FIG. 7 is a diagram illustrating an example of a NAL unit structure of an SVC bitstream. Referring to FIG. 7, the SVR bitstream 600 includes a 3 byte or 4 byte start prefix code 710 that classifies NAL units, and a NAL unit 730. The NAL unit 730 includes a NAL unit header 731, a NAL unit header SVC extension header 733, and NAL data 735.

The NAL unit 730 includes SEI including a field of information association with a configuration of a base layer and an enhancement of an SVC bitstream, an SPS including a field of entire encoding information associated with a profile and label of a video sequence, a PPS non-VCL NAL unit including a field of information associated with an encoding mode of a full video screen, and a VCL NAL unit including slice data obtained by encoding a single screen into a slice unit.

The VCL NAL unit may include slice data encoded into a slice unit based on a base layer and an enhancement layer, and a slice header and a slice header in scalable extension.

The NAL unit header 731 includes nal unit type field information used to identify a non-VCL NAL unit and a VCL NAL unit.

The NAL unit header SVC extension header 733 may provide layer information of spatial, temporal, and image quality frames through dependence_id, quality_id, and temporal_id field information.

The NAL data 735 includes SEI, SPS, and PPS field information of a non-VCL NAL unit, or actual encoding data of a VCL NAL unit.

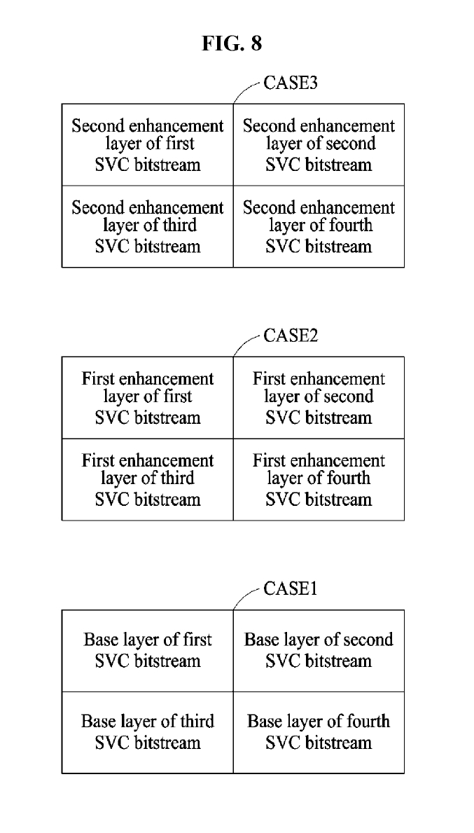

FIG. 8 is a diagram illustrating examples of a single SVC bitstream.

For convenience of description, four remote locations are provided herein as the plurality of remote locations 100.

Referring to FIG. 8, CASE1 illustrates a single SVC bitstream including a base layer, for example, the base layer 610 illustrated in FIG. 6, that is extracted from a mixed SVC bitstream based on a reception environment of the user device 300, CASE2 illustrates a single SVC bitstream including a first enhancement layer, for example, the first enhancement layer 630 illustrated in FIG. 6, that is extracted from the mixed SVC bitstream based on the reception environment of the user device 300, and CASE3 illustrates a single SVC bitstream including a second enhancement layer, for example, the second enhancement layer 650 illustrated in FIG. 6, that is extracted from the mixed SVC bitstream based on the reception environment of the user device 300.

The mixed SVC bitstream in CASE1, CASE2, and CASE3 may be a single SVC bitstream including a plurality of layers, in which a first SVC bitstream of a first remote location 100-1, a second SVC bitstream of a second remote location 100-2, a third SVC bitstream of a third remote location 100-3, and a fourth SVC bitstream of a fourth remote location 100-4 are mixed based on each layer.

That is, the single SVC bitstream may be a single SVC bitstream including a single layer, which is obtained by mixing a plurality of SVC bitstreams including a plurality of layers based on the reception environment of the user device 300.

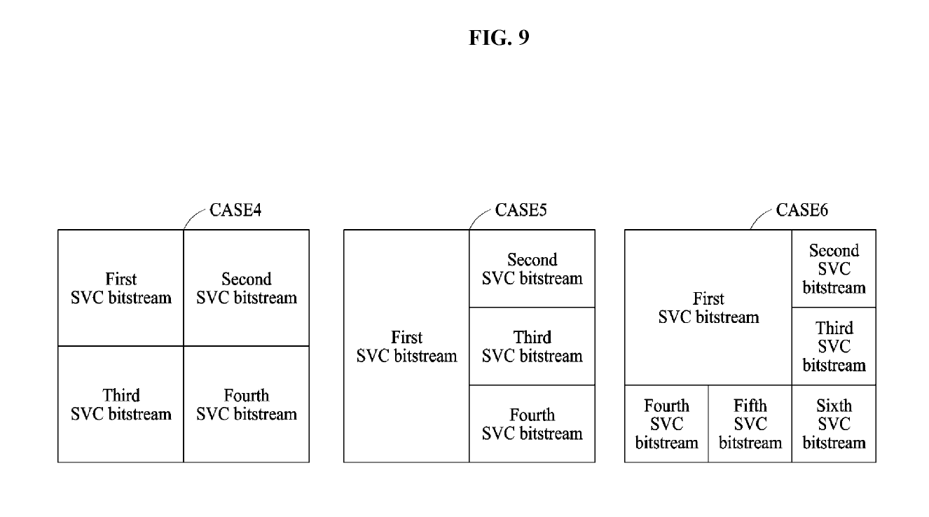

FIG. 9 is a diagram illustrating examples of a screen configuration of the user device 300.

For convenience of description, six remote locations are provided herein as the plurality of remote locations 100.

Referring to FIG. 9, examples of a screen configuration of the user device 300 are illustrated as CASE4, CASE5, and CASE6.

CASE4, CASE5, and CASE6 each illustrates a screen configuration associated with a single SVC bitstream that is obtained by mixing a plurality of SVC bitstreams transmitted from the remote locations 100, and through extracting and decoding. For example, a full screen illustrated in each of CASE4, CASE5, and CASE6 is a finally mixed screen in which a plurality of SVC bitstreams is mixed, which is to be displayed on the user device 300. In addition, the full screen illustrated in each CASE4, CASE5, and CASE6 is a finally mixed screen that is obtained by mixing different sized final screens of SVC bitstreams of remote locations 100-1 through 100-4.

As illustrated in CASE4, the video bitstream mixing apparatus 200 may transmit, to the user device 300, only a single SVC bitstream including SVC bitstreams of a first remote location 100-2, a second remote location 100-2, a third remote location 100-3, and a fourth remote location 100-4, based on a reception environment of the user device 300. Here, a screen of the single SVC bitstream may be configured by equally setting sizes of the SVC bitstreams of the first remote location 100-2, the second remote location 100-2, the third remote location 100-3, and the fourth remote location 100-4.

As illustrated in CASE5, similar to CASE 4, the video bitstream mixing apparatus 200 may transmit, to the user device 300, a single SVC bitstream including the SVC bitstreams of the first remote location 100-1, the second remote location 100-2, the third remote location 100-3, and the fourth remote location 100-4, based on the reception environment of the user device 300.

However, a screen configuration of the single SVC bitstream illustrated in CASE5 is different from that of the single SVC bitstream illustrated in CASE4. Dissimilar to CASE4, a screen of the single SVC bitstream may be configured by differently setting sizes of the SVC bitstreams, with a screen of a first SVC bitstream of the first remote location 100-1 having a size larger than sizes of screens of remaining SVC bitstreams.

As illustrated in CASE6, the video bitstream mixing apparatus 200 may transmit, to the user device 300, a single SVC bitstream including all SVC bitstreams of the remote locations 100 based on the reception environment of the user device 300. Here, a screen of the single SVC bitstream illustrated in CASE6 may be configured by differently setting sizes of the SVC bitstreams, with the screen of the first SVC bitstream of the first remote location 100-1 having a size larger than sizes of screens of remaining SVC bitstreams.

Thus, the video bitstream mixing apparatus 200 may transmit, to the user device 300, a single SVC bitstream with various screen sizes, through mixing of a plurality of SVC bitstreams, and extracting and decoding, based on the reception environment of the user device 300.

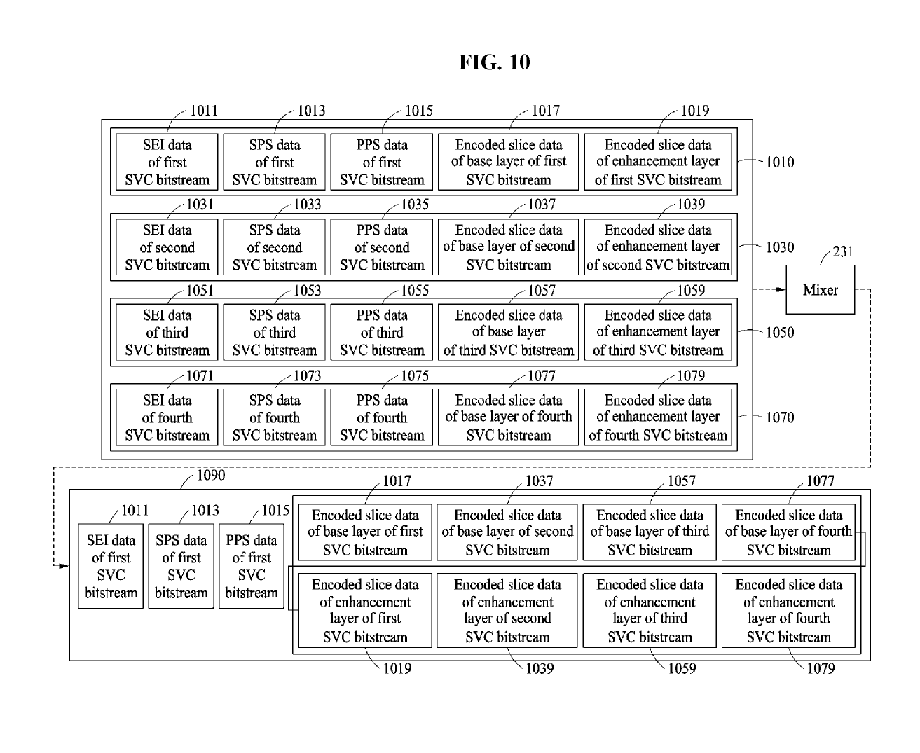

FIG. 10 is a diagram illustrating an example of an operation of the mixer 231.

For convenience of description, four remote locations are provided herein as the plurality of remote locations 100.

Referring to FIG. 10, the mixer 231 may reconstruct a NAL unit by mixing a plurality of SVC bitstreams for each layer. For example, as illustrated, the mixer 231 reconstructs a plurality of SVC bitstreams to be a mixed SVC bitstream by mixing a non-VCL NAL units of a first SVC bitstream 1010 of a first remote location 100-1, a non-VCL NAL unit of a second SVC bitstream 1030 of a second remote location 100-2, a non-VCL NAL unit of a third SVC bitstream 1050 of a third remote location 100-3, and a non-VCL NAL unit of a fourth SVC bitstream 1070 of a fourth remote location 100-4, into the non-VCL NAL unit of the first SVC bitstream 1010 of the first remote location 100-1, and mixing VCL NAL units included in each of a plurality of layers based on each layer.

The non-VCL NAL unit of the first SVC bitstream 1010 of the first remote location 100-1 includes SEI data 1011, SPS data 1013, and PPS data 1015, and the VCL NAL unit of the first SVC bitstream 1010 includes encoded slice data 1017 of a base layer and encoded slice data 1019 of an enhancement layer.

The non-VCL NAL unit of the second SVC bitstream 1030 of the second remote location 100-2 includes SEI data 1031, SPS data 1033, and PPS data 1035, and the VCL NAL unit of the second SVC bitstream 1030 includes encoded slice data 1037 of a base layer and encoded slice data 1039 of an enhancement layer.

The non-VCL NAL unit of the third SVC bitstream 1050 of the third remote location 100-3 includes SEI data 1051, SPS data 1053, and PPS data 1055, and the VCL NAL unit of the third SVC bitstream 1050 includes encoded slice data 1057 of a base layer and encoded slice data 1059 of an enhancement layer.

The non-VCL NAL unit of the fourth SVC bitstream 1070 of the fourth remote location 100-4 includes SEI data 1071, SPS data 1073, and PPS data 1075, and the VCL NAL unit of the fourth SVC bitstream 1070 includes encoded slice data 1077 of a base layer and encoded slice data 1079 of an enhancement layer.

A mixed SVC bitstream 1090 includes the SEI data 1011, the SPS data 1013, and the PPS data 1015 of the non-VCL NAL unit of the first SVC bitstream 1010, and the VCL NAL units of the layers. Here, the VCL NAL units of the base layers include the encoded slice data 1017 of the VCL NAL unit of the first SVC bitstream 1010, the encoded slice data 1037 of the VCL NAL unit of the second SVC bitstream 1030, the encoded slice data 1057 of the VCL NAL unit of the third SVC bitstream 1050, and the encoded slice data 1077 of the VCL NAL unit of the fourth SVC bitstream 1070. The VCL NAL units of the enhancement layers include the encoded slice data 1019 of the VCL NAL unit of the first SVC bitstream 1010, the encoded slice data 1039 of the VCL NAL unit of the second SVC bitstream 1030, the encoded slice data 1059 of the VCL NAL unit of the third SVC bitstream 1050, and the encoded slice data 1079 of the VCL NAL unit of the fourth SVC bitstream 1070.

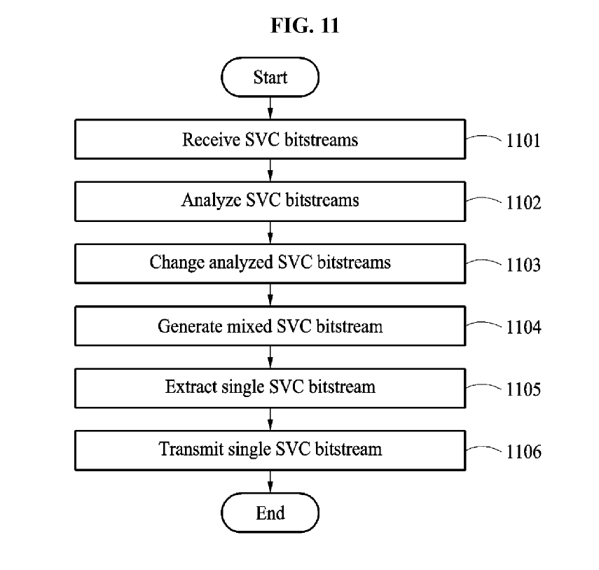

FIG. 11 is a flowchart illustrating an example of a method to be performed by the video bitstream mixing apparatus 200 illustrated in FIG. 1.

Referring to FIG. 11, in operation 1101, the video bitstream mixing apparatus 200 receives a plurality of SVC bitstreams including a single base layer and a plurality of enhancement layers, which is transmitted from the plurality of remote locations 100.

In operation 1102, the video bitstream mixing apparatus 200 analyzes the SVC bitstreams for each NAL unit.

In operation 1103, the video bitstream mixing apparatus 200 changes the analyzed SVC bitstreams based on a screen arrangement configuration parameter of the user device 300.

In operation 1104, the video bitstream mixing apparatus 200 generates a mixed SVC bitstream including a plurality of layers by mixing the changed SVC bitstreams for each layer.

In operation 1105, the video bitstream mixing apparatus 200 extracts, from the mixed SVC bitstream, a single SVC bitstream corresponding to a single layer based on a reception environment of the user device 300.

In operation 1106, the video bitstream mixing apparatus 200 transmits, to the user device 300, the single SVC bitstream including the single layer.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of mixing video bitstreams, the method comprising:
generating a scalable video coding (SVC) bitstream by mixing a plurality of SVC bitstreams of layers based on a screen configuration of a user device;
extracting, from the SVC bitstream generated according to the mixing, a single SVC bitstream corresponding to a single layer based on a reception environment of the user device; and
transmitting the single SVC bitstream to the user device.

2. The method of claim 1, wherein the plurality of SVC bitstreams each including a single base layer and a plurality of enhancement layers are transmitted from a plurality of remote locations.

3. The method of claim 1, wherein the generating comprises:
analyzing the plurality of SVC bitstreams by each network abstraction layer (NAL) unit, and
according to a result of the analyzing, mixing the analyzed plurality of SVC bitstreams based on a screen arrangement configuration parameter of the user device.

4. The method of claim 3, wherein the analyzing comprises:
identifying a NAL unit by analyzing information of a header of a NAL unit of each of the plurality of SVC bitstreams, and
according to a result of the identifying, selecting a NAL unit of the plurality of SVC bitstreams based on the screen arrangement configuration parameter of the user device.

5. The method of claim 3, wherein the mixing comprises:
changing a sequence parameter set (SPS) of a reference bitstream among the analyzed plurality of SVC bitstreams,
changing a slice header of each of the analyzed plurality of SVC bitstreams based on the screen arrangement configuration parameter of the user device, and
wherein the SVC bitstream is generated by re-arranging the changed plurality of SVC bitstreams based on an order of the layers included in each of the changed plurality of SVC bitstreams.

6. The method of claim 5, wherein the changing of the SPS comprises:
changing a field value of a horizontal size and a field value of a vertical size of a final screen to be mixed based on a resolution of a finally mixed screen.

7. The method of claim 5, wherein the changing of the slice header comprises:
changing a macro-block start address field value of a slice header associated with slice data of a base layer and an enhancement layer included in each of the analyzed plurality of SVC bitstreams.

8. The method of claim 5, wherein the generating comprises:
calculating a bit number of a NAL unit including slice data of each of the changed plurality of SVC bitstreams based on macro-block address information of a slice header associated with slice data of each of a base layer and an enhancement layer included in each of the changed plurality of SVC bitstreams.

9. The method of claim 8, wherein the calculating comprises:
arranging bytes of a slice NAL unit by inserting a raw byte sequence payload (RBSP) trailing bit into calculated slice data.

10. An apparatus for mixing video bitstreams, the apparatus comprising:
at least one hardware processor configured to:
generate a scalable video coding (SVC) bitstream by mixing a plurality of SVC bitstreams of layers based on a screen configuration of a user device;
extract, from the SVC bitstream generated according to the mixing, a single SVC bitstream corresponding to a single layer based on a reception environment of the user device; and
a decoder configured to transmit the single SVC bitstream to the user device.

11. The apparatus of claim 10, wherein the plurality of SVC bitstreams each including a base layer and a plurality of enhancement layers are transmitted from a plurality of remote locations.

12. The apparatus of claim 10, further comprising:
a buffer configured to provide the plurality of SVC bitstreams by each network abstraction layer (NAL) unit based on a buffer fullness, and
the at least one hardware processor is further configured to:
analyze the plurality of SVC bitstreams by each NAL unit, and
mix the analyzed plurality of SVC bitstreams based on a screen arrangement configuration parameter of the user device according to a result of the analyzing.

13. The apparatus of claim 12, wherein the at least one hardware processor is configured to identify a NAL unit by analyzing information of a header of a NAL unit of each of the plurality of SVC bitstreams, and select a NAL unit of the plurality of SVC bitstreams based on the screen arrangement configuration parameter of the user device according to a result of the identifying.

14. The apparatus of claim 12, wherein the at least one hardware processor is further configured to:
change a sequence parameter set (SPS) of a reference bitstream among the analyzed plurality of SVC bitstreams,
change a slice header of each of the analyzed plurality of SVC bitstreams based on the screen arrangement configuration parameter of the user device, and
re-arrange the changed plurality of SVC bitstreams based on an order of the layers included in each of the changed plurality of SVC bitstreams.

15. The apparatus of claim 14, wherein the at least one hardware processor is configured to change a field value of a horizontal size and a field value of a vertical size of a final screen to be mixed based on a resolution of a finally mixed screen.

16. The apparatus of claim 14, wherein the at least one hardware processor is configured to change a macro-block start address field value of a slice header associated with slice data of a base layer and an enhancement layer included in each of the analyzed plurality of SVC bitstreams.

17. The apparatus of claim 14, wherein the at least one hardware processor is configured to calculate a bit number of a NAL unit including slice data of each of the changed plurality of SVC bitstreams based on macro-block address information of a slice header associated with slice data of each of a base layer and an enhancement layer included in each of the changed plurality of SVC bitstreams.

18. The apparatus of claim 17, wherein the at least one hardware processor is configured to arrange bytes of a slice NAL unit by inserting a raw byte sequence payload (RBSP) trailing bit into calculated slice data.
